(19) United States
(12) Patent Application Publication
(10) Pub. No.: US 2005/0288933 A1
(43) Pub. Date: Dec. 29, 2005

(54) Information input method and apparatus

(76) Inventors: Yayoi Nakamura, Yokohama (JP); Shingo Suzumori, Yokohama (JP); Toshihiro Ide, Yokohama (JP); Hiroshi Sugitani, Yokohama (JP); Daisuke Namoto, Yokohama (JP); Tomokazu Katsuro, Yokohama (JP)

Correspondence Address: KATTEN MUCHIN ROSENMAN LLP, 575 MADISON AVENUE, NEW YORK, NY, 10022-2585, US

(21) Appl. No.: 10/974,032

(22) Filed: Oct. 26, 2004

(30) Foreign Application Priority Data
Jun. 23, 2004 (JP) 2004-185249

(51) Int. Cl. G10L 21/00

(52) U.S. Cl. 704/270

(57) ABSTRACT

An information input method inputs certain information and probability information having uncertainty. The information input method displays a plurality of candidates with respect to the probability information that is input, and selects and fixes one of the plurality of displayed candidates in response to the certain information that is input.

### BACKGROUND OF THE INVENTION

This application claims the benefit of a Japanese Patent Application No. 2004-185249 filed Jun. 23, 2004, in the Japanese Patent Office, the disclosure of which is hereby incorporated by reference.

1. Field of the Invention

The present invention generally relates to information input methods and apparatuses, and more particularly to an information input method and an information input apparatus which input both certain information and uncertain information, where input contents are certain (or definite) and may be uniquely determined in the case of the certain information and the input contents are uncertain (or indefinite) and may not be uniquely determined in the case of the uncertain information. The uncertain information may be treated as probability information.

2. Description of the Related Art

A call center system accepts calls from users at a call center. The calls from the users include inquiries, claims, orders and the like related to products or items. An operator of the call center manually inputs information using a keyboard, mouse and the like. In addition, it is conceivable to subject speeches of the user and the operator to a speech recognition, so as to input a speech recognition result to the call center system.

Contents of the information input from the keyboard, mouse and the like are certain (or definite) and may be uniquely determined. Such information will be referred to as “certain information” in this application. On the other hand, in the case of the speech recognition, the speech recognition result may be in error or, only a portion of the speech may be recognized by the speech recognition. For this reason, contents of the information input based on the speech recognition result are uncertain (or indefinite) and may not be uniquely determined. Such information will be referred to as “probability information” in this application. The probability information is of course not limited to the information based on the speech recognition result, and may include any uncertain information, such as information based on an image recognition result and information based on character recognition result (or optical character reader (OCR) recognition result).

A Japanese Laid-Open Patent Application No. 10-322450 proposes subjecting a user's speech to a speech recognition and displaying a speech recognition result, so that an operator may read back (or repeat) the user's speech. The operator's speech that is made by reading back the user's speech is also subjected to a speech recognition. Of the speech recognition result of the user's speech and the speech recognition result of the operator's speech, the speech recognition result with a higher recognition rate is selectively output as a final speech recognition result, and is used as an input to a system.

A Japanese Laid-Open Patent Application No. 2003-316374 proposes including, in annotation data, a specified speaker data that is obtained by subjecting a speech of a specified speaker at a receiving end to a speech recognition, an unspecified speaker data that is obtained by subjecting a speech of an unspecified speaker at a sending end to a speech recognition, and a keyboard data that is input by the specified speaker simultaneously as the call. Further, the specified speaker repeats the speech of the unspecified speaker, so as to facilitate the speech recognition.

However, the certain information input from the keyboard, mouse and the like, and the probability information obtained through the speech recognition and the like have the following problems.

It takes time to input the certain information from the keyboard, mouse and the like. The keyboard input takes time because all words and the like must be input without error, and also because it requires operator's concentration. In a case where the operator of the call center makes the keyboard input while speaking with the user, the operator may not be able to concentrate on both the keyboard input and the conversation. If the operator cannot concentrate on the keyboard input, an erroneous keyboard input is easily made. If the operator cannot concentrate on the conversation, an erroneous keyboard input may be made based on an erroneous understanding of the conversation contents. Moreover, if the operator decides to concentrate on the conversation and make the keyboard input later, the operator may forget to make the necessary keyboard input afterwards.

On the other hand, the probability information is uncertain or indefinite, because it is obtained through the speech recognition and the like which may inevitably include a recognition error. The speech recognition basically selects one of candidate words which are registered in advance, which most closely resembles the sound of the word that is obtained as the speech recognition result. For this reason, a large number of candidate words need to be registered, and the speech recognition is difficult in that there is a possibility of not selecting the correct candidate word. The speech recognition rate (or the degree of speech recognition certainty) has improved over the years, but it is still impossible to make the speech recognition without the speech recognition error. These problems of the speech recognition similarly occur in the image recognition and the character (or OCR) recognition.

Therefore, in the case of the call center system, for example, it takes time if the certain information is manually input by the operator from the keyboard, mouse and the like. The speech recognition selects only one of the candidate words having the highest recognition rate (or the degree of speech recognition certainty), and the selected candidate word is used as the probability information. However, since the recognition rate of the speech recognition is not 100%, the candidate word having the highest recognition rate is not necessarily the correct word, and the accuracy of the probability information may be low.

In addition, in the case of the speech recognition, if the number of registered candidate words increases, the recognition rate correspondingly decreases. Hence, in the case of the call center system, the decrease in the recognition rate results in the increase in the uncertainty of the probability information.

### SUMMARY OF THE INVENTION

Accordingly, it is a general object of the present invention to provide a novel and useful information input method and apparatus, in which the problems described above are suppressed.

Another and more specific object of the present invention is to provide an information input method and an information input apparatus, which can quickly input information with a high accuracy.

Still another object of the present invention is to provide an information input method for inputting certain information and probability information having uncertainty, comprising displaying a plurality of candidates with respect to the probability information that is input; and selecting and fixing one of the plurality of displayed candidates in response to the certain information that is input. According to the information input method of the present invention, it is possible to quickly input information with a high accuracy.

A further object of the present invention is to provide an information input apparatus comprising a certain information input unit configured to input certain information; a probability information input unit configured to input probability information having uncertainty, and to obtain a plurality of candidates with respect to the probability information; a candidate display unit configured to display the plurality of candidates; and a selecting and fixing unit configured to fix and select one of the plurality of displayed candidates in response to the certain information input by the certain information input unit. According to the information input apparatus of the present invention, it is possible to quickly input information with a high accuracy.

Other objects and further features of the present invention will be apparent from the following detailed description when read in conjunction with the accompanying drawings.

### BRIEF DESCRIPTION OF THE DRAWINGS

FIG. 1 is a system block diagram showing an embodiment of an information input apparatus according to the present invention;

FIG. 2 is a functional block diagram showing the embodiment of the information input apparatus;

FIG. 3 is a sequence diagram for explaining a conversation at a call center;

FIG. 4 is a diagram showing document structure candidates;

FIGS. 5A, 5B and 5C respectively are diagrams showing candidate words;

FIG. 6 is a flow chart for explaining a probability information input process of the embodiment of the information input apparatus;

FIGS. 7A, 7B and 7C respectively are diagrams for explaining the probability information input process;

FIGS. 8A, 8B and 8C respectively are diagrams for explaining the probability information input process;

FIG. 9 is a diagram showing a display on a display device;

FIG. 10 is a flow chart for explaining a probability information fixing process of the embodiment of the information input apparatus;

FIG. 11 is a flow chart for explaining a probability information limiting process of the embodiment of the information input apparatus by input of certain information;

FIG. 12 is a diagram showing a display on the display device together with candidates for recognition;

FIG. 13 is a diagram showing a display on the display device;

FIG. 14 is a flow chart for explaining a probability information limiting process of the embodiment of the information input apparatus by input item selection;

FIG. 15 is a diagram showing a display on the display device together with candidates for recognition;

FIG. 16 is a flow chart for explaining a coping content determining process of the embodiment of the information input apparatus by conversation example selection;

FIG. 17 is a diagram showing a display on the display device;

FIG. 18 is a flow chart for explaining a probability information limiting process of the embodiment of the information input apparatus by one-character selection;

FIG. 19 is a diagram showing a display on the display device together with candidates for recognition;

FIG. 20 is a flow chart for explaining a coping content determining process of the embodiment of the information input apparatus by process flow selection;

FIG. 21 is a diagram showing a display on the display device;

FIG. 22 is a flow chart for explaining a candidate word display sequence changing process of the embodiment of the information input apparatus;

FIG. 23 is a diagram showing a display on the display device;

FIG. 24 is a flow chart for explaining a candidate word certainty changing process of the embodiment of the information input apparatus; and

FIG. 25 is a diagram showing a display on the display device.

### DESCRIPTION OF THE PREFERRED EMBODIMENTS

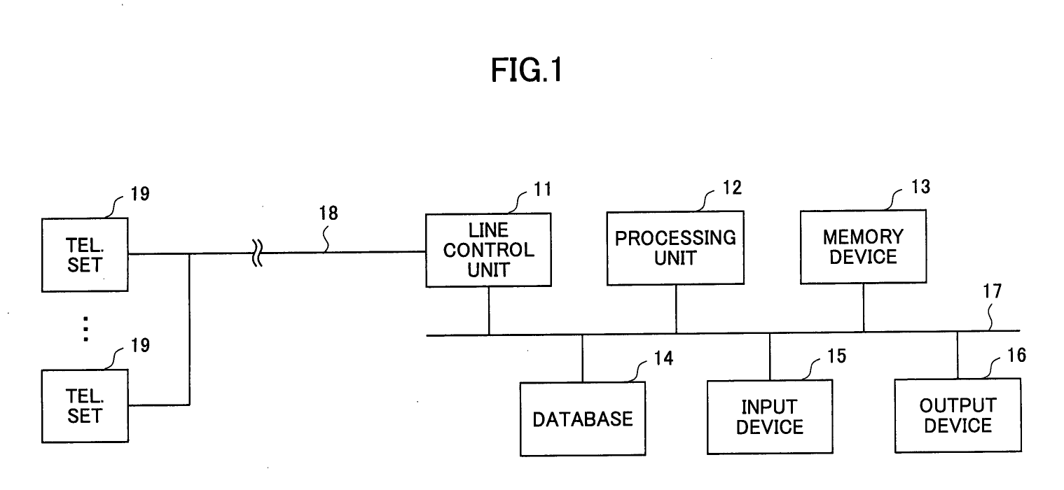

FIG. 1 is a system block diagram showing an embodiment of an information input apparatus according to the present invention. This embodiment of the information input apparatus employs an embodiment of an information input method according to the present invention. The information input apparatus may be an exclusive apparatus or, may be formed by a general-purpose personal computer, work station and the like, for example.

The information input apparatus shown in

FIG. 1 includes a line control unit 11, a processing unit 12, a memory device 13, a database 14, an input device 15 and an output device 16 which are mutually connected via a system bus 17.

The line control unit 11 receives audio signals from telephone sets 19 of users via a public line 18, and sends an audio signal output from a microphone within the input device 15 to the telephone sets 19 via the public line 18. The microphone within the input device 15 picks up the operator's speech. In addition, the line control unit 11 controls the connection and the disconnection of the lines.

The processing unit 12 may be formed by a CPU, MPU or the like. The processing unit 12 executes software programs of various processes stored in the memory device 13, including a speech recognition process. The database 14 includes various databases (DBs) for use by an information input process. The input device 15 includes the microphone, a keyboard, a mouse, and an analog-to-digital converter (ADC) for converting the operator's speech picked up by the microphone into a digital audio signal. The output device 16 includes a display device which functions as a display means, a printer and the like.

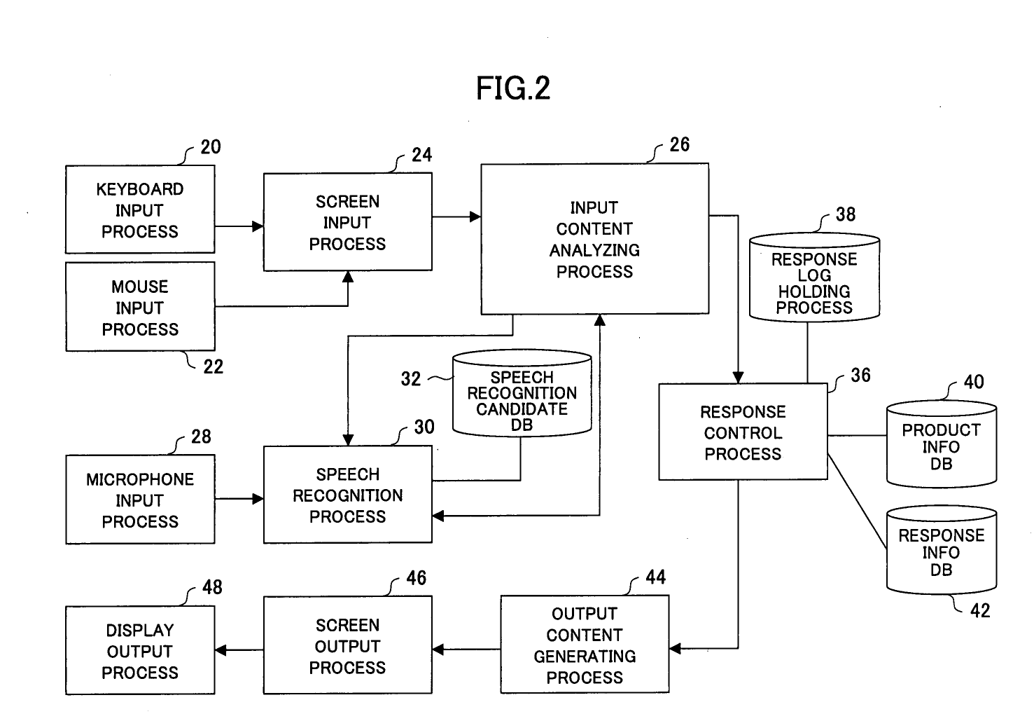

FIG. 2 is a functional block diagram showing the embodiment of the information input apparatus. Various functions, that is, processes or means, shown in FIG. 2 are realized by the software programs executed by the processing unit 12. In FIG. 2, a keyboard input process (or means) 20 reads input information from the keyboard of the input device 15 that is operated by the operator, and supplies the read input information to a screen input process (or means) 24.

A mouse input process (or means) 22 reads input information from the mouse of the input device 15 that is operated by the operator, and supplies the read input information to the screen input process (or means) 24. The screen input process (or means) 24 supplies the input information from the keyboard or mouse to an input content analyzing process (or means) 26, as certain information, in order to reflect the input information to a display on the display device of the output device 16.

A microphone input process (or means) 28 inputs the digital audio signal output from the microphone of the input device 15, which picks up the operator's speech, and supplies the digital audio signal to a speech recognition process (or means) 30. The speech recognition process (or means) 30 uses document structure candidates and candidate words that are registered in advance in a speech recognition candidate database 32 within the database 14, and carries out a speech recognition with respect to the digital audio signal received from the microphone input process (or means) 28. A plurality of candidate words and certainties are obtained as a speech recognition result, and the speech recognition process (or means) 30 supplies the speech recognition result to the input content analyzing process (or means) 26, as probability information. The speech recognition does not recognize the entire document, but carries out a word spot recognition to recognize only candidate words, that are registered in advance, within the document.

The input content analyzing process (or means) 26 notifies the certain information received from the screen input process (or means) 24 to the speech recognition process (or means (30), and of the probability information received from the speech recognition process (or means) 30, groups candidate words having the same contents into a single item. The input content analyzing process (or means) 26 generates a display request for displaying the candidate words in an order of the highest certainty for each item, and also generates a display request for displaying the certain information. The input content analyzing process (or means) 26 supplies the generated display requests to a response control process (or means) 36. The response control process (or means) 36 determines display contents using a response log holding process (or means) 38, and a product information database 40 and a response information database 42 within the database 14, and supplies the determined display contents to an output content generating process (or means) 44.

The output content generating process (or means) 44 generates screen layout data for displaying a screen in accordance with the display contents, and character data of characters, numerals, symbols and the like, and outputs a screen output request to an image output process (or means) 46. The image output process (or means) 46 generates image data of a display screen based on the screen output request. The image data is supplied to the display device of the output device 16 via a display output process (or means) 48, and is displayed on the display device.

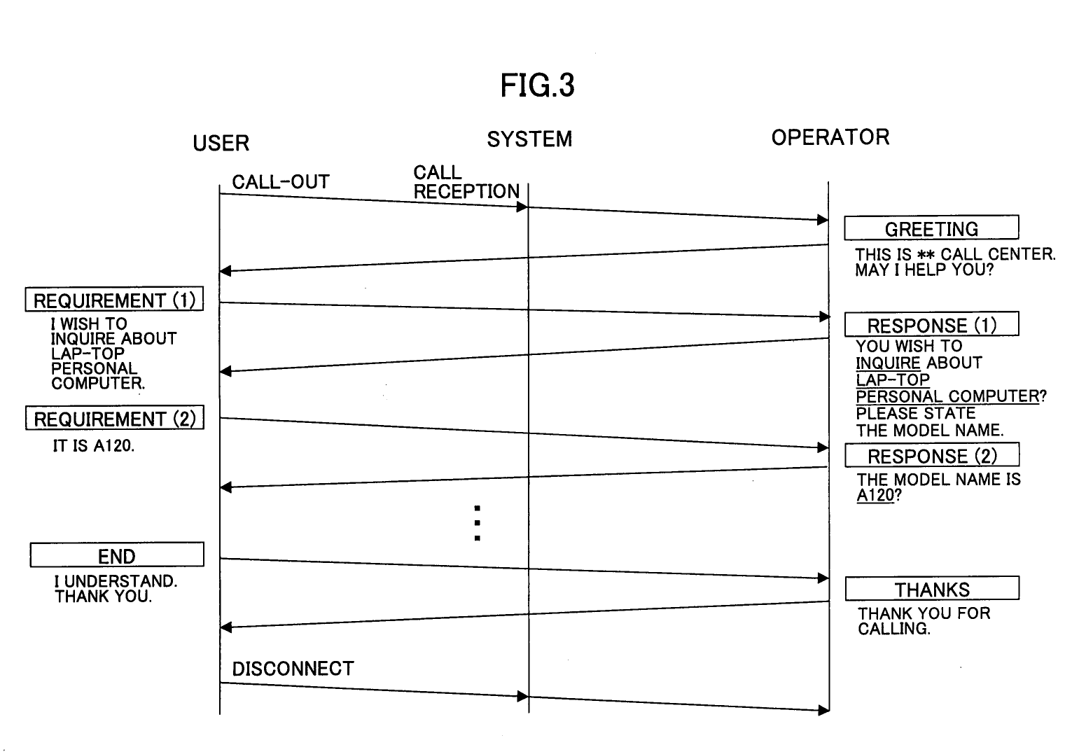

FIG. 3 is a sequence diagram for explaining a conversation at a call center. In FIG. 3, when the operator responds to a call from the user, the user speaks a requirement (or requisite) (1) “I wish to inquire about lap-top personal computer.”. In response to this requirement (1), the operator speaks a response (1) “You wish to inquire about lap-top personal computer? Please state the model name.”. Next, when the user speaks a requirement (2) “It is A120.”, the operator speaks a response (2) “The model name is A120?”.

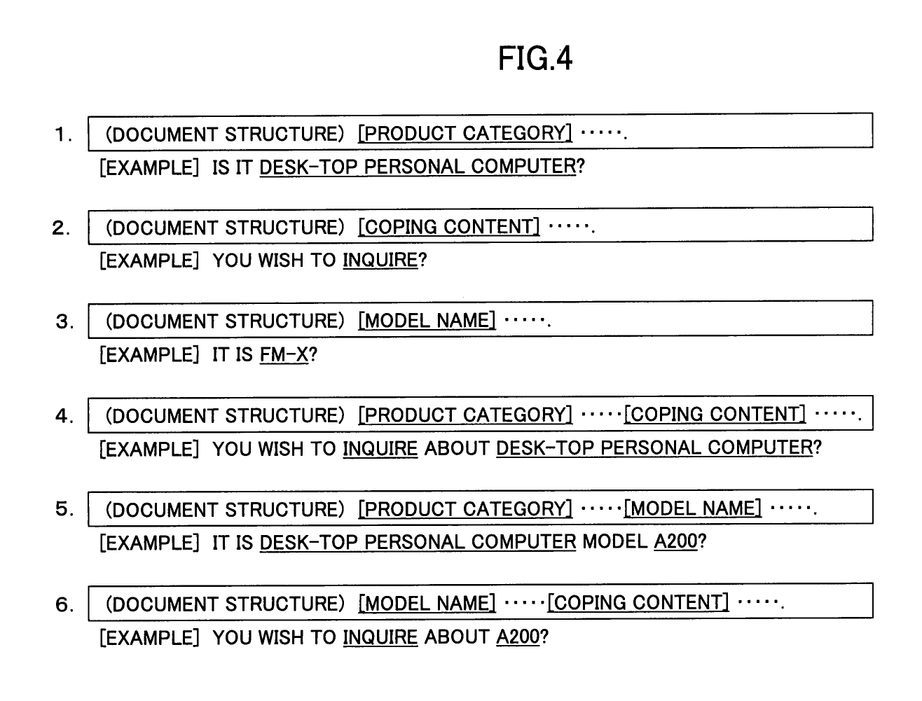

FIG. 4 is a diagram showing the document structure candidates registered in the speech recognition candidate database 32. In FIG. 4, a document structure candidate 1 is for recognizing a product category, a document structure candidate 2 is for recognizing a coping content, a document structure candidate 3 is for recognizing a model name, a document structure candidate 4 is for recognizing a product category and a coping content, a document structure candidate 5 is for recognizing a product category and a model name, and a document structure candidate 6 is for recognizing a model name and a coping content.

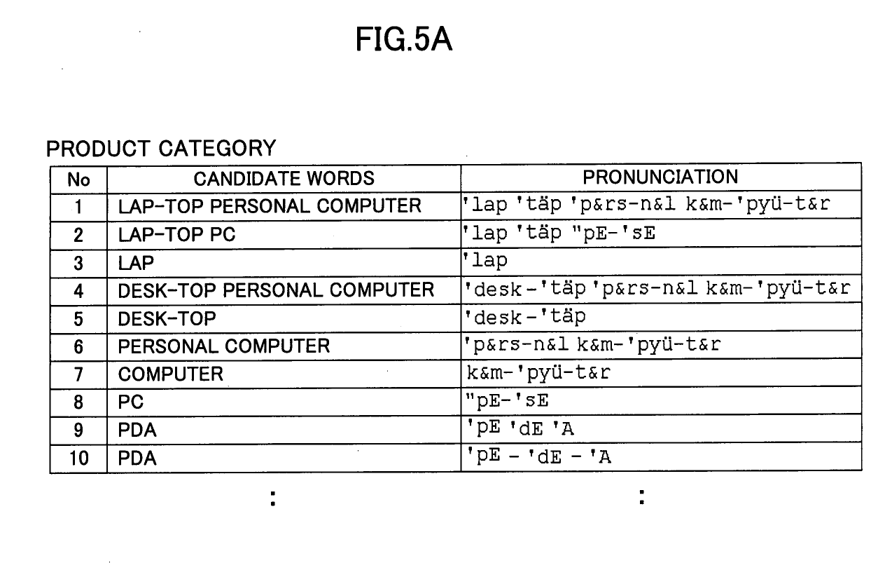

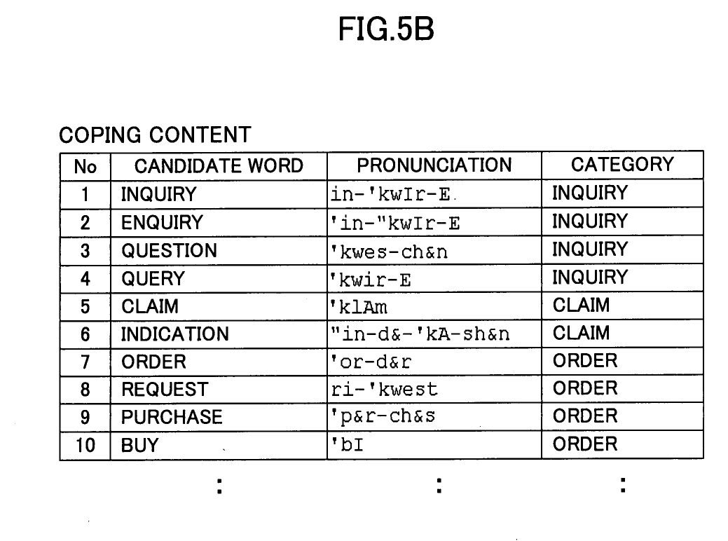

FIGS. 5A, 5B and 5C respectively are diagrams showing the candidate words registered in the speech recognition candidate database 32.

FIG. 5A shows a table of candidate words for items corresponding to the product category. In correspondence with the candidate word “lap-top personal computer”, for example, audio data “'lap 'täp 'p&rs-n&l k&m-' pyü-t&r” indicating how this candidate word is read (or pronounced) is registered in the table shown in FIG. 5A. In FIG. 5A and the subsequent figures, the pronunciation is indicated by phonetic symbols (or signs) employed by Merriam-Webster Online Dictionary, for the sake of convenience.

FIG. 5B shows a table of candidate words for items corresponding to the coping content. In correspondence with the candidate word “inquiry”, for example, audio data “in-'kwlr-E” indicating how this candidate word is read (or pronounced) is registered in the table shown in FIG. 5B. The table shown in FIG. 5B also registers a category for each of the candidate words, such as “inquiry”, “claim” and “order”.

FIG. 5C shows a table of candidate words for items corresponding to the model name. In correspondence with the candidate word “model name”, for example, audio data indicating how this candidate word is read (or pronounced) is registered in the table shown in FIG. 5C. The audio data for the candidate word “A110” include “'A-'w&n-'w&n-'0” and “'A-'w&n-'w&n-'zE-(″)r0” in FIG. 5C, but may include others such as “'A-′w&n-i-' le-v&n”. The table shown in FIG. 5C also registers a product category for each of the candidate words, such as “lap-top personal computer”.

Next, a description will be given of a probability information display process that is carried out when the conversation shown in FIG. 3 is made at the call center and the response (2) is made.

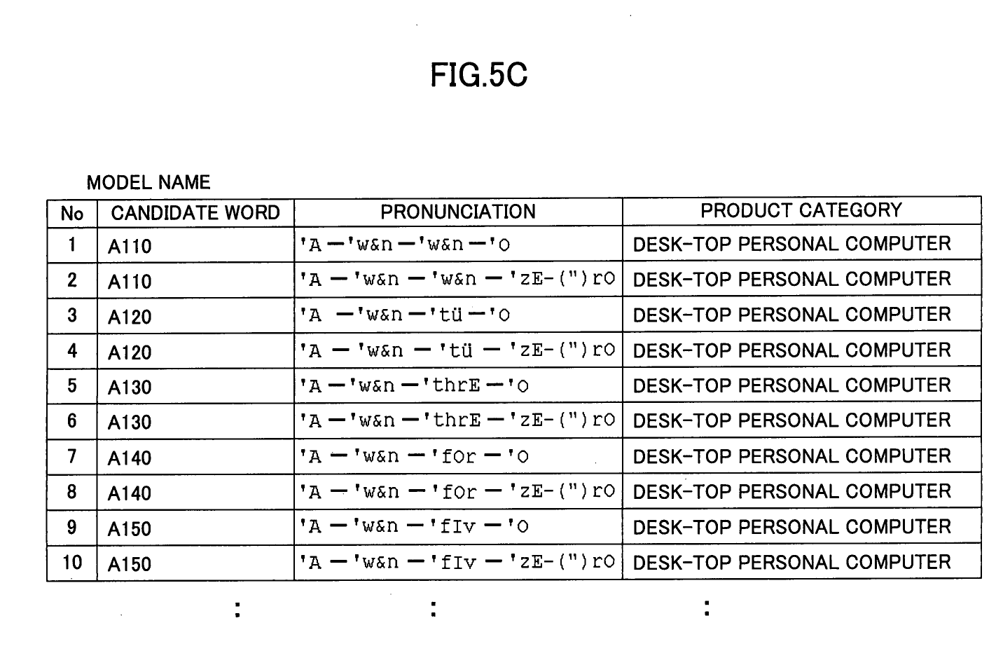

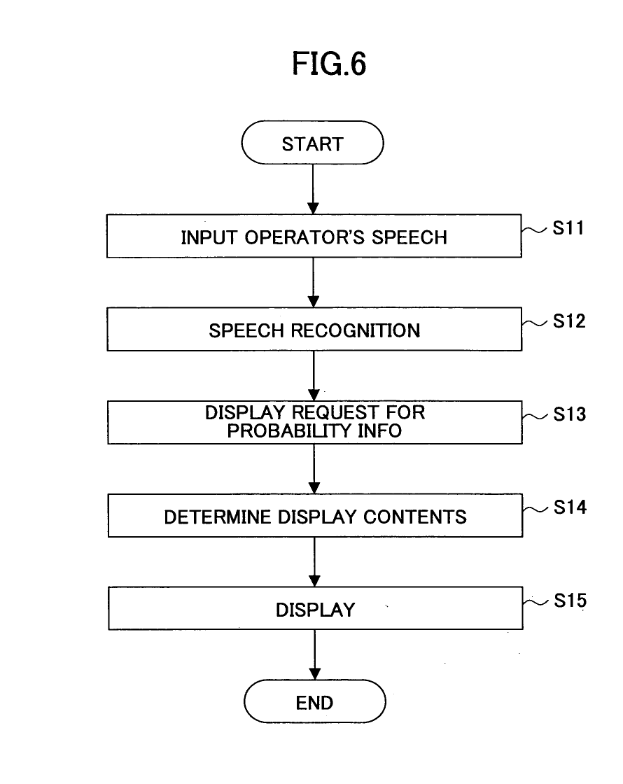

FIG. 6 is a flow chart for explaining a probability information input process of this embodiment of the information input apparatus. In FIG. 6, when the operator makes an input by speech, the microphone input process (or means) 28 inputs the audio signal of the operator's speech and supplies the audio signal to the speech recognition process (or means) 30, in a step S11. The speech recognition process (or means) 30 carries out the speech recognition with respect to the audio signal using the document structure candidates and the candidate words that are registered in advance in the speech recognition candidate database 32, obtains a plurality of candidate words and certainties as a speech recognition result, and supplies the speech recognition result to the input content analyzing process (or means) 26 as probability information, in a step S12.

The input content analyzing process (or means) 26 generates a display request for displaying and determining the probability information received from the speech recognition process (or means) 30, and supplies the display request to the response control process (or means) 36, in a step S13. The response control process (or means) 36 determines the display contents using the response log holding process (or means) 38 within the memory device 13 and the product information database 40 and the response information database 42 within the database 14, and supplies the display contents to the output content generating process (or means) 44, in a step S14.

The output content generating process (or means) 44 generates the screen layout data and the character data according to the display contents, and supplies a screen output request to the screen output process (or means) 46, in a step S15. The screen output process (or means) 46 generates the image data of the display screen based on the screen output request, and displays the image data on the screen of the display device, so as to urge the operator to input the certain information.

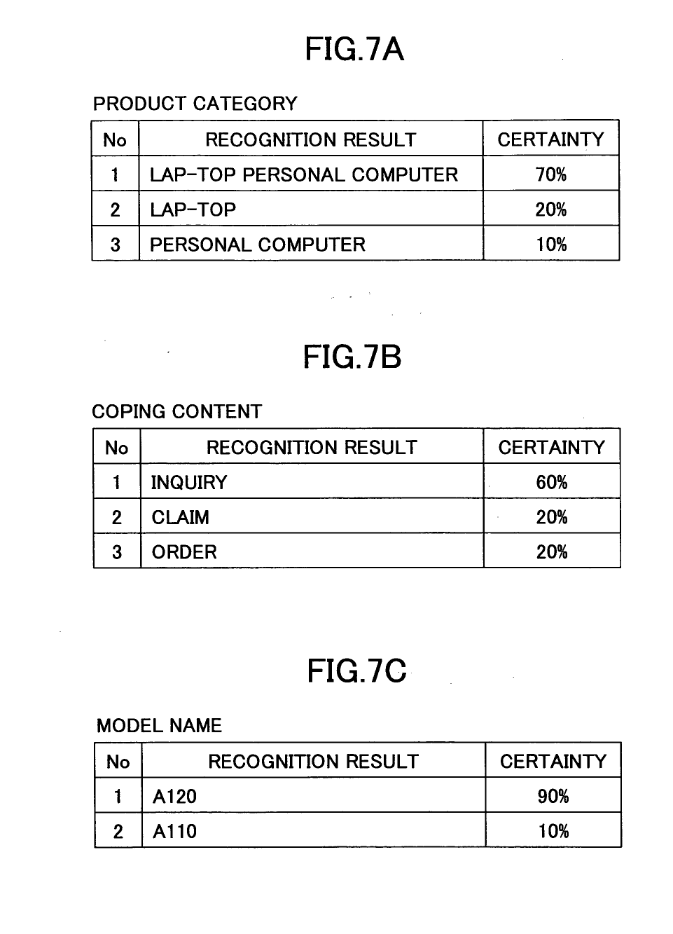

FIGS. 7A, 7B and 7C respectively are diagrams for explaining the probability information input process. Based on the responses (1) and (2) of the operator, the speech recognition process (or means) 30 supplies to the input content analyzing process (or means) 26, as probability information, the 3 candidate words and their certainties for the product categories shown in FIG. 7A, the 3 candidate words and their certainties for the coping contents shown in FIG. 7B, and the 2 candidate words and their certainties for the model name shown in FIG. 7C.

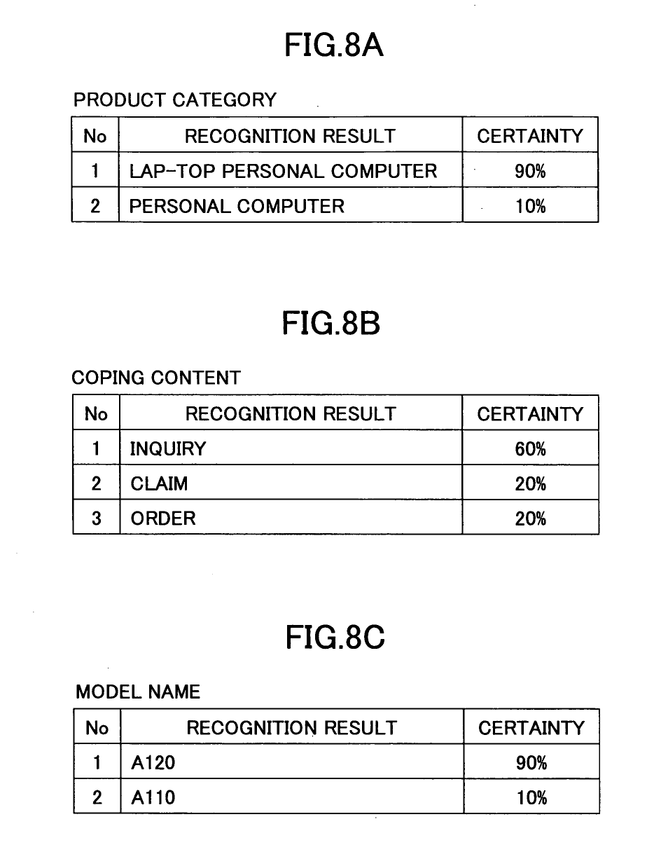

FIGS. 8A, 8B and 8C respectively are diagrams for explaining the probability information input process. Of the probability information received from the speech recognition process (or means) 30, the input content analyzing process (or means) 26 groups candidate words having the same contents into a single item, and supplies the 2 candidate words and their certainties shown in FIG. 8A to the response control process (or means) 36. Since there are not candidate words having the same contents for the coping content and the model name, the input content analyzing process (or means) 26 supplies the items shown in FIGS. 8B and 8C to the response control process (or means) 36.

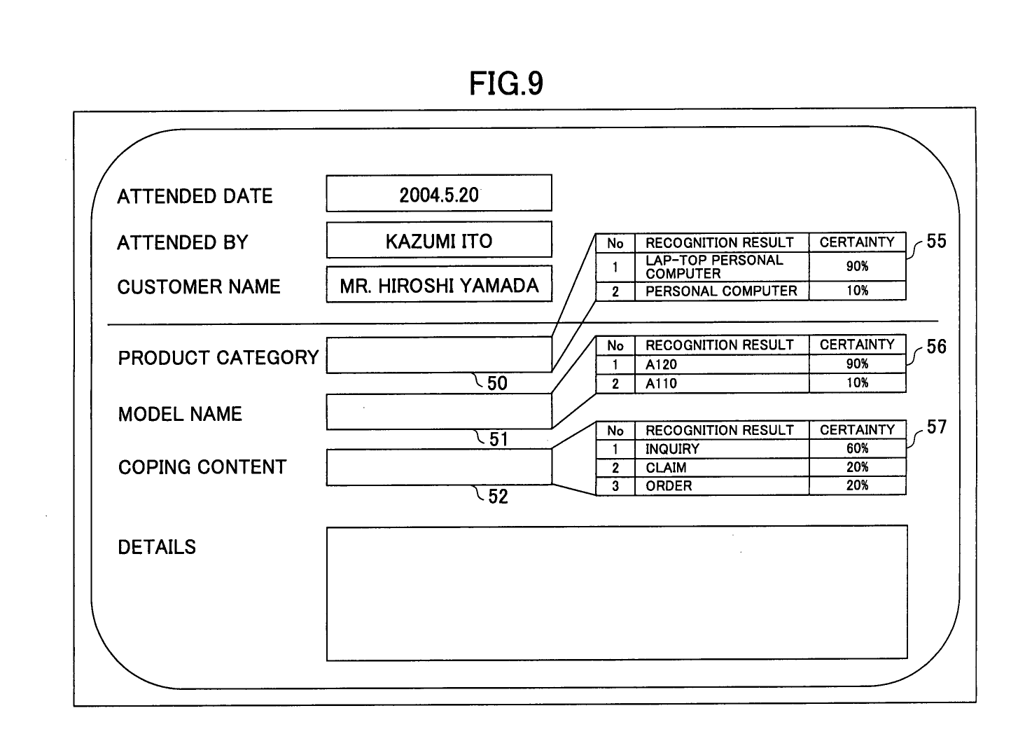

As a result, a display shown in FIG. 9 is displayed on the display device. FIG. 9 is a diagram showing the display made on the display device. As shown in FIG. 9, candidate word tables 55, 56 and 57 of the product category, the model name and the coping content are respectively displayed in vicinities of fixed (or definite) display regions 50, 51 and 52 for the product category, the model name and the coping content. One or a plurality of candidate words and their certainties are displayed in the candidate word tables 55, 56 and 57. Of course, the candidate word tables 55, 56 and 57 only need to display at least the candidate word, and it is not essential to display the certainty of the candidate word.

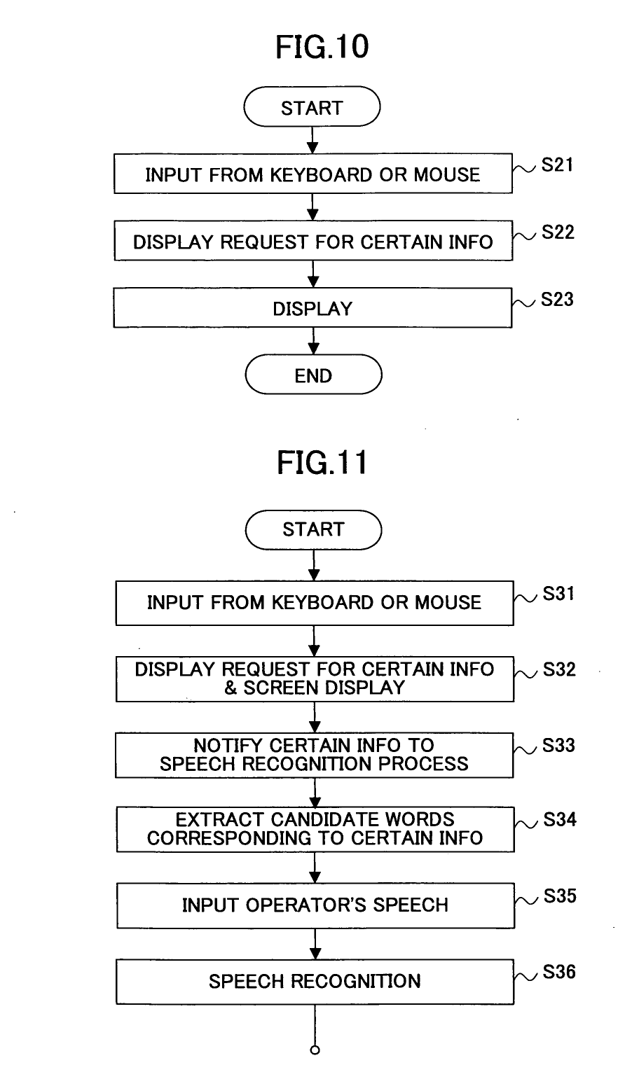

FIG. 10 is a flow chart for explaining a probability information fixing process of the embodiment of the information input apparatus. This probability information fixing process is carried out in response to an operation of the keyboard or mouse in a state where the probability information is displayed as shown in FIG. 9.

In FIG. 10, when the operator makes an input from the keyboard or mouse, the keyboard input process (or means) 20 or the mouse input process (or means) 22 reads the input information that selects a specific candidate word from each of the candidate word tables 55, 56 and 57 in response to the operator's operation, and the screen input process (or means) 24 supplies the candidate words selected by the input information, as certain information, to the input content analyzing process (or means) 26, in a step S21.

The input content analyzing process (or means) 26 generates a display request for displaying the selected candidate words as the certain information in the fixed display regions 50, 51 and 52, and supplies the display request to the response control process (or means) 36, in a step S22. The input content analyzing process (or means) 26 stops the display of the candidate word tables 55, 56 and 57 with respect to the item for which the candidate word is selected.

The response control process (or means) 36 generates the screen layout data and the character data according to the display contents, and outputs a screen output request to the screen output process (or means) 46, so as to displays the image data on the screen of the display device, in a step S23.

FIG. 11 is a flow chart for explaining a probability information limiting process of the embodiment of the information input apparatus by input of the certain information.

In FIG. 11, when the operator makes an input from the keyboard or mouse, the keyboard input process (or means) 20 or the mouse input process (or means) 22 reads the input information (for example, “lap-top personal computer”) that is input to the fixed display region 50, and the screen input process (or means) 24 supplies the input information, as the certain information, to the input content analyzing process (or means) 26, in a step S31.

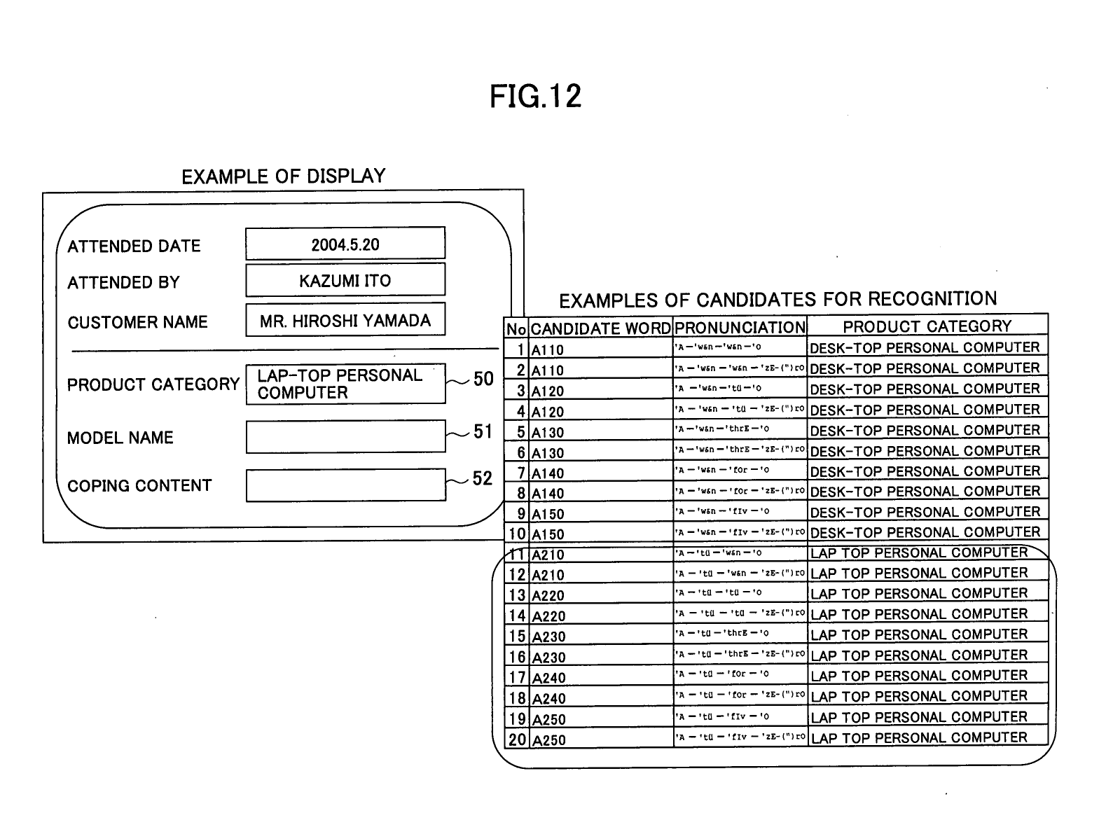

The input content analyzing process (or means) 26 generates a display request for displaying the selected candidate word, as the certain information, in the fixed display region 50, and supplies the display request to the response control process (or means) 36 and notifies this to the output content generating process (or means) 44, in a step S32. The output content generating process (or means) 44 generates the screen layout data and the character data according to the display contents, and supplies a screen output request to the screen output process (or means) 46. Hence, a display having “lap-top personal computer” input in the fixed display region 50 is displayed on the screen of the display device, as shown in FIG. 12. FIG. 12 is a diagram showing the display on the display device together with the recognized candidates.

The input content analyzing process (or means) 26 notifies the certain information to the speech recognition process (or means) 30, in a step S33. The speech recognition process (or means) 30 extracts only the candidate words corresponding to the certain information from the candidate words that are registered in advance in the speech recognition candidate database 32, in a step S34.

Next, when the operator makes an input by speech, the microphone input process (or means) 28 inputs the audio signal of the operator's speech and supplies the audio signal to the speech recognition process (or means) 30, in a step S35. The speech recognition process (or means) 30 carries out the speech recognition with respect to the audio signal using the document structure candidates that are registered in advance in the speech recognition candidate database 32 and the extracted candidate words, in a step S36.

A plurality of candidate words and certainties are obtained as the speech recognition result. The plurality of candidate words and certainties are supplied to the input content analyzing process (or means) 26, as probability information, and displayed on the display device, similarly as in the case of the process shown in FIG. 6. In this case, candidate words including “desk-top personal computer” and “lap-top personal computer” are registered in the candidate word table of the model name in the speech recognition candidate database 32 as shown in FIG. 12, but only the candidate word corresponding to the certain information “lap-top personal computer” is extracted and used for the speech recognition. Consequently, the recognition rate (or the degree of speech recognition certainty) of the speech recognition can be improved. The candidate words of the model names shown in FIG. 12 are not actually displayed on the screen of the display device.

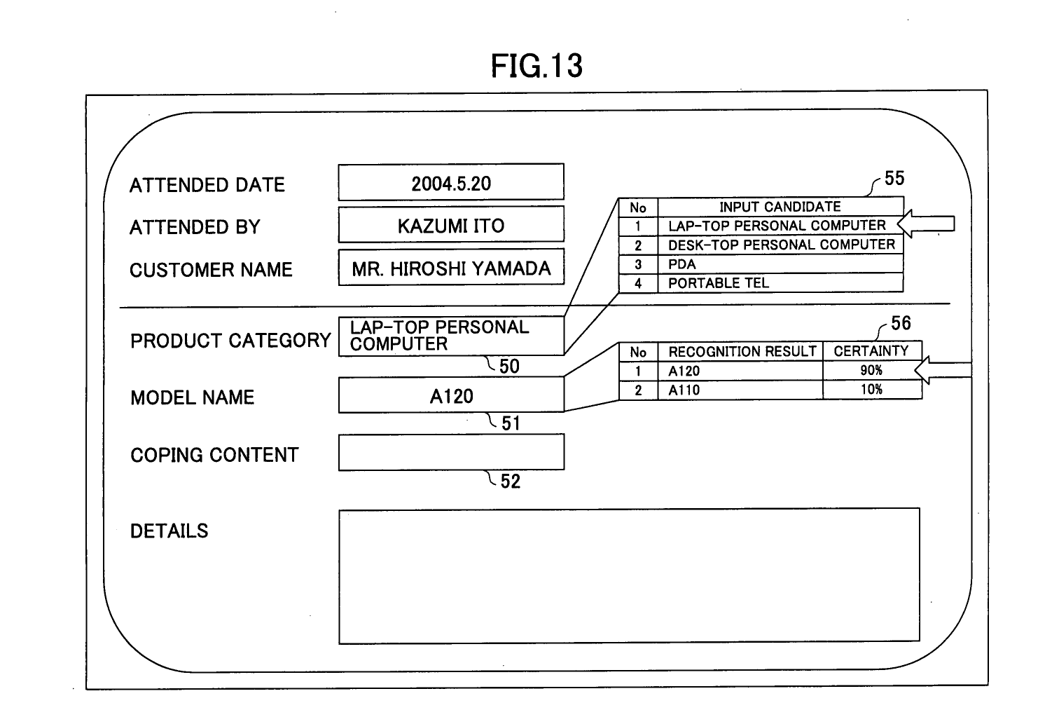

According to the probability information fixing process shown in FIG. 10, the operator selects the specific candidate word by the mouse or the like from each of the candidate word tables 55, 56 and 57, so as to obtain the certain information. But in the candidate word table of the model name in the speech recognition candidate database 32 shown in FIG. 5C, the product category is registered together with the model name, and when a model name, which is a subordinate concept of the product category, is fixed, it becomes possible to also fix the product category of the higher concept. For this reason, when the model name “A120” is selected by the mouse or the like from the candidate word table 56 shown in FIG. 13 and is fixed, the product category “lap-top personal computer” is simultaneously fixed from the candidate word table 55. FIG. 13 is a diagram showing the display on the display device. Thus, it is possible to reduce the operations to be carried out by the operator.

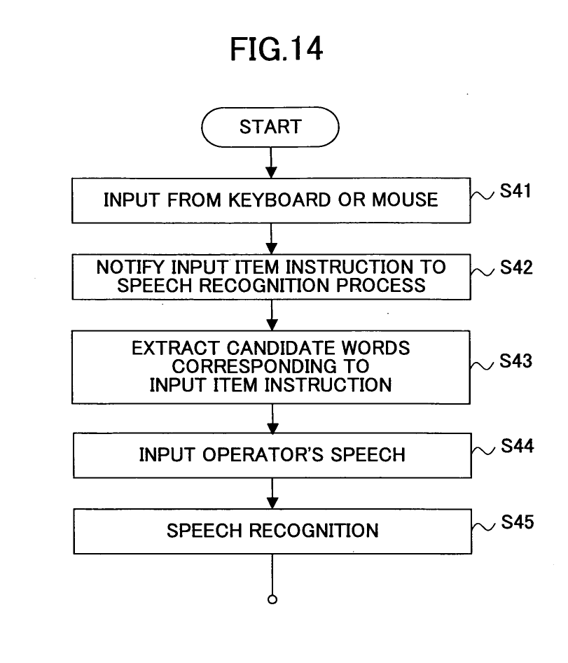

FIG. 14 is a flow chart for explaining a probability information limiting process of the embodiment of the information input apparatus by input item selection.

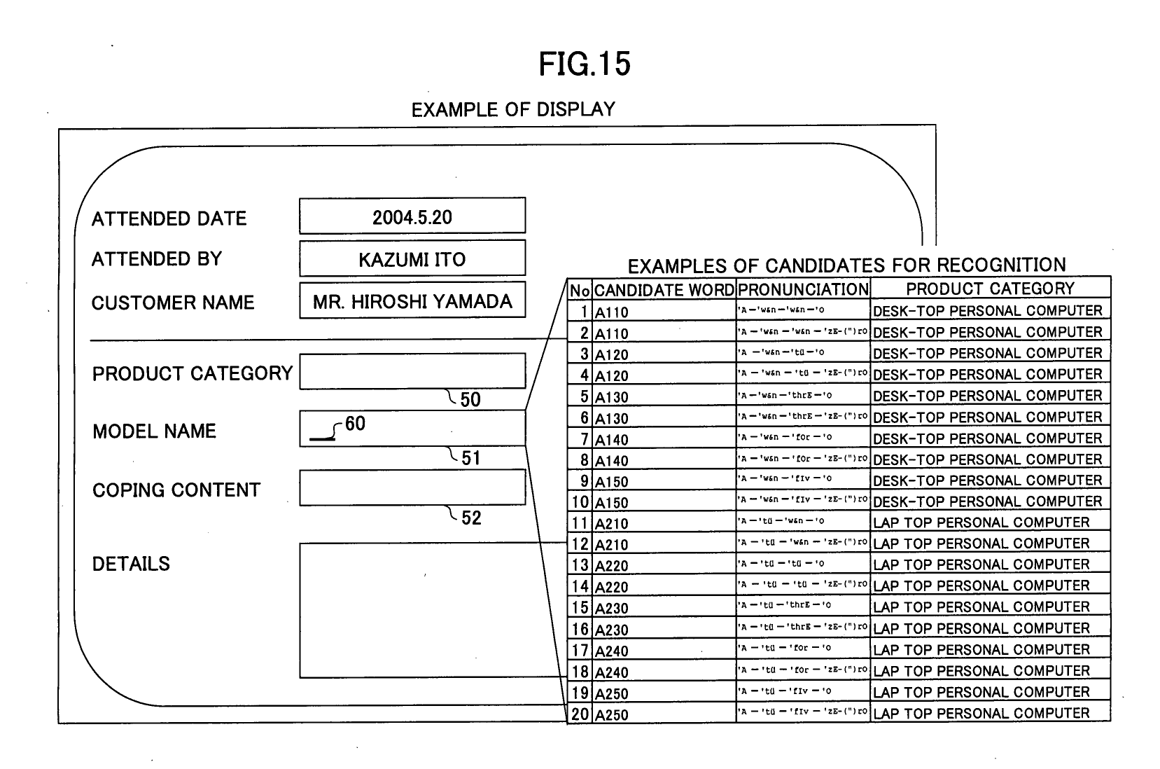

In FIG. 14, when the operator makes an input operation from keyboard or mouse to move a cursor to one of the fixed display regions 50 through 52, the keyboard input process (or means) 20 or the mouse input process (or means) 22 reads the cursor position as the input information of an input item instruction, and the screen input process (or means 24 supplies the input information to the input content analyzing process (or means) 26, as the certain information, in a step S41. FIG. 15 is a diagram showing a display on the display device together with candidates for recognition. More particularly, FIG. 15 shows the display in which a cursor 60 instructs the fixed display region 51 as the input item.

The input content analyzing process (or means 26 notifies the certain information of the input item instruction to the speech recognition process (or means) 30, in a step S42. The speech recognition process (or means) 30 extracts candidate words corresponding to the certain information of the input item instruction, from the candidate words that are registered in advance in the speech recognition candidate database 32, in a step S43.

Next, when the operator makes an input by speech, the microphone input process (or means) 28 inputs the audio signal of the operator's speech and supplies the audio signal to the speech recognition process (or means) 30, in a step S44. The speech recognition process (or means) 30 carries out the speech recognition with respect to the audio signal using the document structure candidates that are registered in advance in the speech recognition candidate database 32 and the extracted candidate words, in a step S45.

A plurality of candidate words and certainties are obtained as the speech recognition result. The plurality of candidate words and certainties are supplied to the input content analyzing process (or means) 26, as probability information, and displayed on the display device, similarly as in the case of the process shown in FIG. 6.

In this case, candidate words of the items, namely, the product category, the model name and the coping content shown in FIGS. 5A through 5C, are registered in the speech recognition candidate database 32. However, only the candidate word corresponding to the model name corresponding to the certain information “lap-top personal computer” of the input item instruction is extracted and used for the speech recognition, as shown in FIG. 15. Consequently, the recognition rate (or the degree of speech recognition certainty) of the speech recognition can be improved. The candidate words of the model names shown in FIG. 15 are not actually displayed on the screen of the display device.

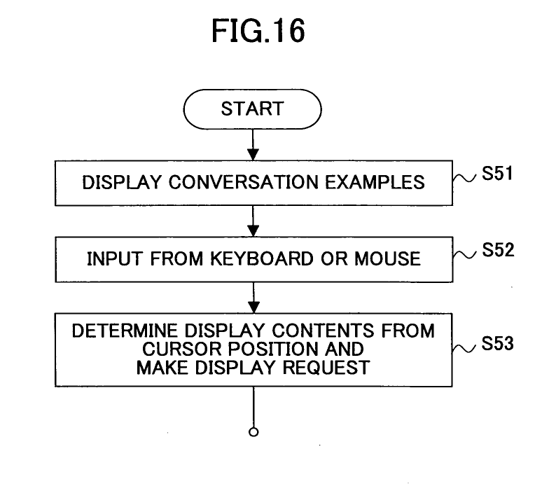

FIG. 16 is a flow chart for explaining a coping content determining process of the embodiment of the information input apparatus by conversation example selection.

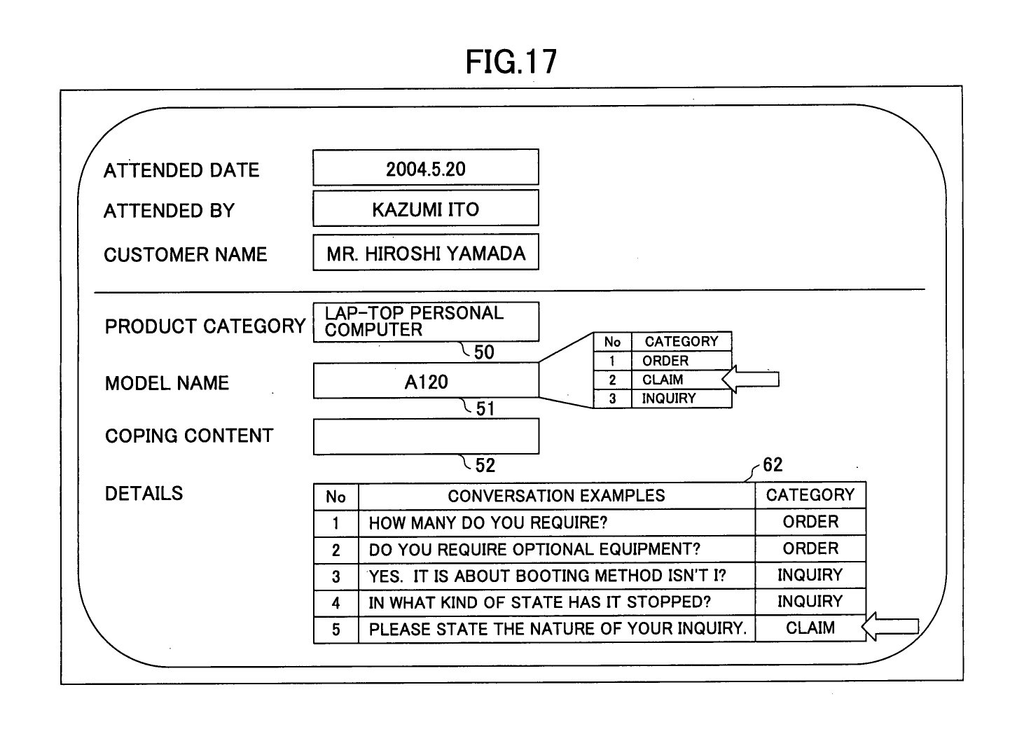

In FIG. 16, in a state where the product category and the model name are fixed, the response control process (or means) 36 uses the response information database 42 to display conversation examples corresponding to the product category and the model name on the screen of the display device, in a step S51. FIG. 17 is a diagram showing a display on the display device. More particularly, FIG. 17 shows conversation examples 62 that are displayed on the display device. The conversation examples 62 that are displayed include phrases most frequently spoken by the operator to the user in a state where the product category and the model name are fixed, and the category of the coping content is also displayed with the phrases.

When the operator makes an input operation from the keyboard or mouse to move the cursor to one of the phrases in the conversation examples 62, the keyboard input process (or means) 20 or the mouse input process (or means) 22 reads the cursor position as the input information of the category instruction, and the screen input process (or means) 24 supplies the input information to the input content analyzing process (or means) 26, as certain information, in a step S52.

The input content analyzing process (or means) 26 generates a display request for displaying the certain information of the category instruction in the fixed display region 52, and supplies the display request to the response control process (or means) 36, in a step S53. Thereafter, the display is made on the display device, similarly as in the case of the process shown in FIG. 6.

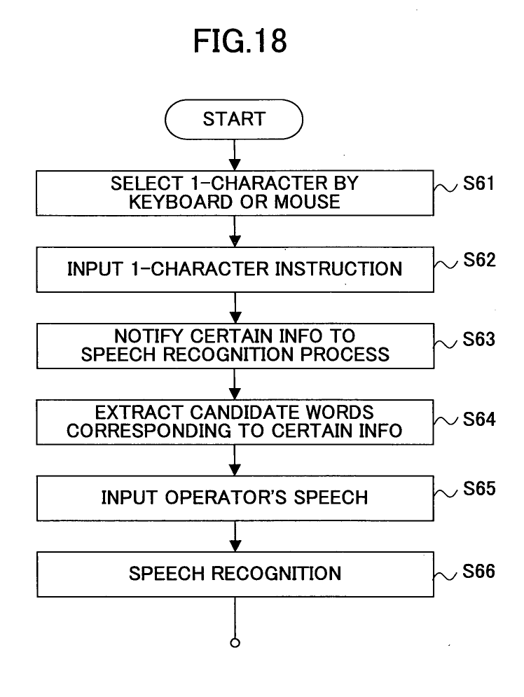

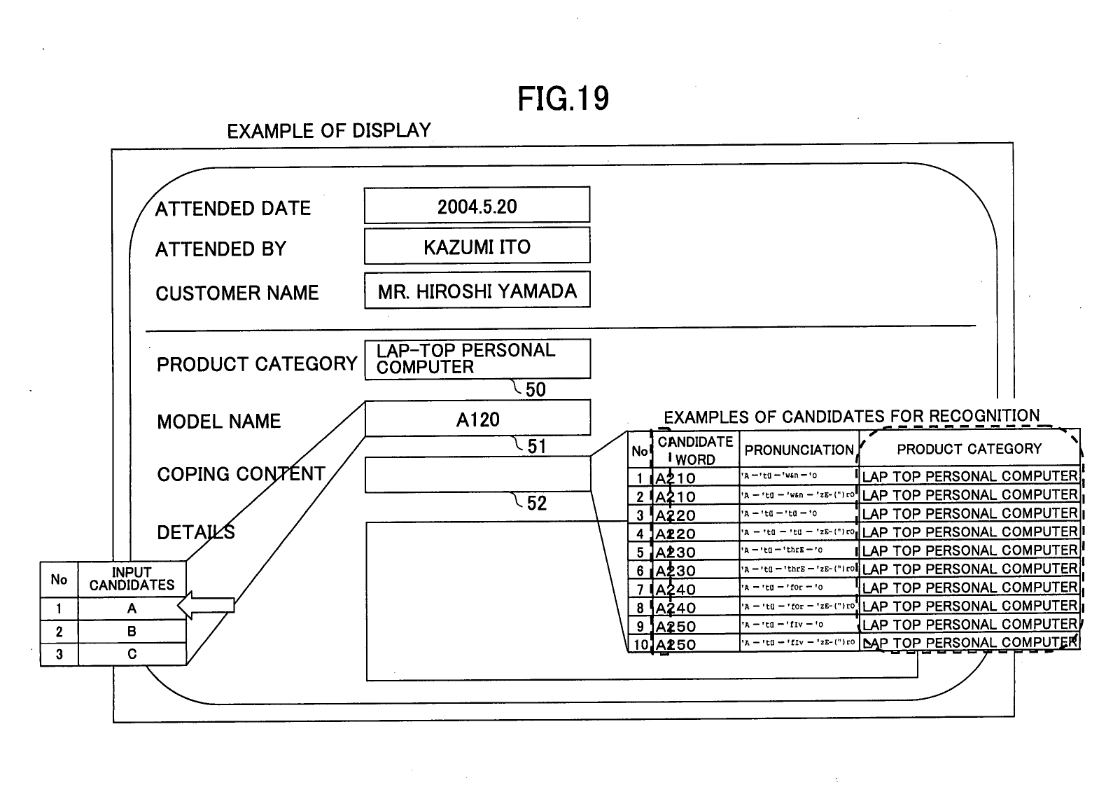

FIG. 18 is a flow chart for explaining a probability information limiting process of the embodiment of the information input apparatus by one-character selection, and FIG. 19 is a diagram showing a display on the display device together with candidates for recognition. FIG. 18 shows the probability information limiting process for a case where “lap-top personal computer” is input and fixed in the fixed display region 50 as shown in FIG. 19 and a character selection table 64 is displayed in a vicinity of the fixed display region 51 for the model name.

In FIG. 18, when the operator makes an input operation from the keyboard or mouse to move the cursor to one of the characters in the character selection table 64 in a step S61, the keyboard input process (or means) 20 or the mouse input process (or means) 22 reads the cursor position as the input information of a one-character instruction, and the screen input process (or means) 24 supplies the input information to the input content analyzing process (or means) 26, as the certain information, in a step S62.

The input content analyzing process (or means) 26 notifies the certain information to the speech recognition process (or means) 30, in a step S63. The speech recognition process (or means) 30 extracts only the candidate words corresponding to the certain information of the one-character instruction, from the candidate words that are registered in advance in the speech recognition candidate database 32, in a step S64.

Next, when the operator makes an input by speech, the microphone input process (or means) 26 inputs the audio signal of the operator's speech and supplies the audio signal to the speech recognition process (or means) 30, in a step S65. The speech recognition process (or means) 30 carries out a speech recognition with respect to the audio signal using the document structure candidates that are registered in advance in the speech recognition candidate database 32 and the extracted candidate words, in a step S66.

A plurality of candidate words and certainties are obtained as the speech recognition result. The plurality of candidate words and certainties are supplied to the input content analyzing process (or means) 26, as probability information, and displayed on the display device, similarly as in the case of the process shown in FIG. 6.

In this case, the candidate words for “lap-top personal computer” are registered in the candidate word table of the model name in the speech recognition candidate database 32 as shown in FIG. 19, but only the candidate words corresponding to the certain information “A” of the one-character instruction are extracted and used for the speech recognition. Consequently, the recognition rate (or the degree of speech recognition certainty) of the speech recognition can be improved. The candidate words of the model names shown in FIG. 19 are not actually displayed on the screen of the display device.

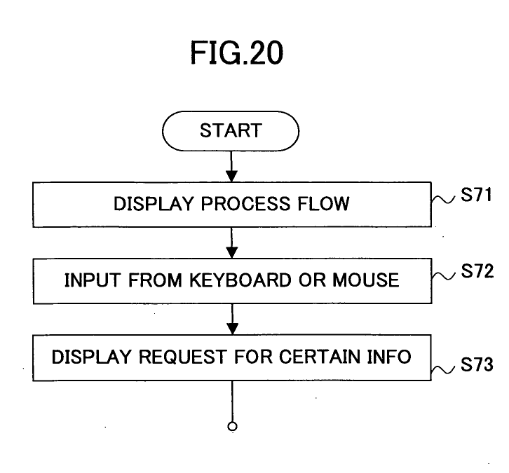

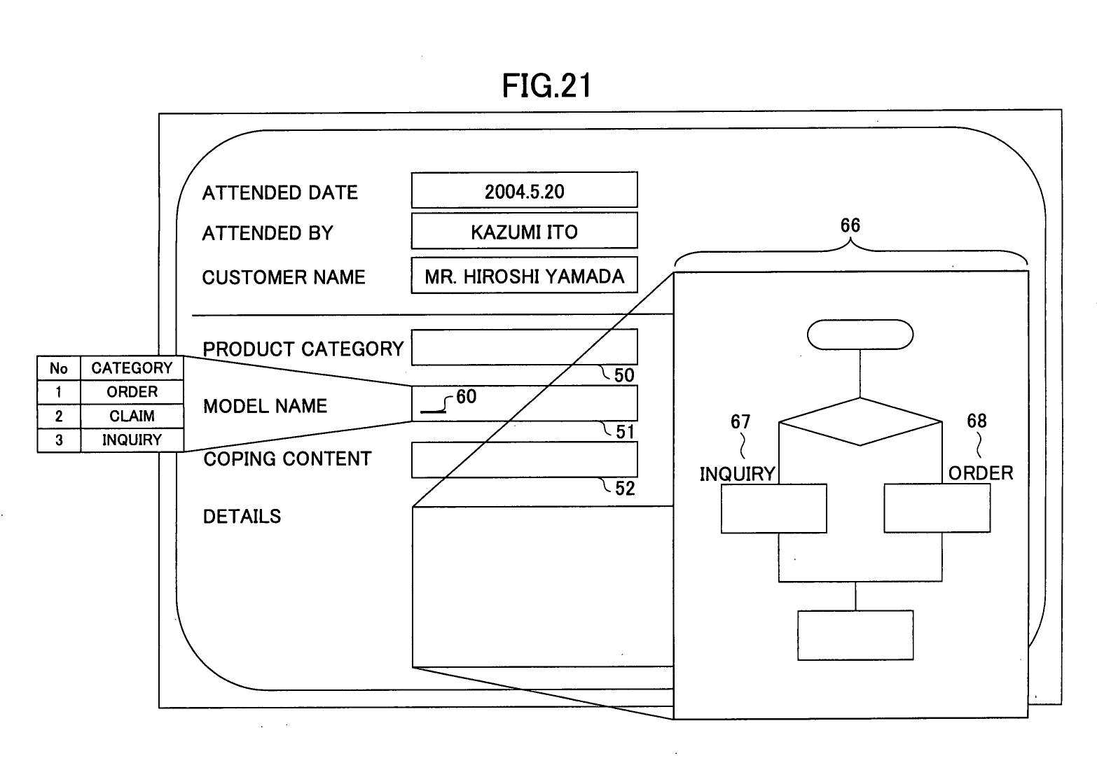

FIG. 20 is a flow chart for explaining a coping content determining process of the embodiment of the information input apparatus by process flow selection, and FIG. 21 is a diagram showing a display on the display device.

In FIG. 20, the response control process (or means) 36 uses the response information database 42 to display a process flow on the display device. FIG. 21 shows a case where a process flow 66 is displayed on the display device. The process flow 66 includes categories 67, 68 and the like of the coping content, at a branch portion where the operator makes a selection.

When the operator makes an input operation from the keyboard or mouse to move the cursor to one of the categories 67 and 68 in the process flow 66, the keyboard input process (or means) 20 or the mouse input process (or means) 22 reads the cursor position as the input information of the category instruction, and the screen input process (or means) 24 supplies the input information to the input content analyzing process (or means) 26, as the certain information, in a step S72.

The input content analyzing process (or means) 26 generates a display request for displaying the certain information of the category instruction in the fixed display region 52, and supplies the display request to the response control process (or means) 36, in a step S73. Thereafter, the display is made on the display device, similarly as in the case of the process shown in FIG. 6.

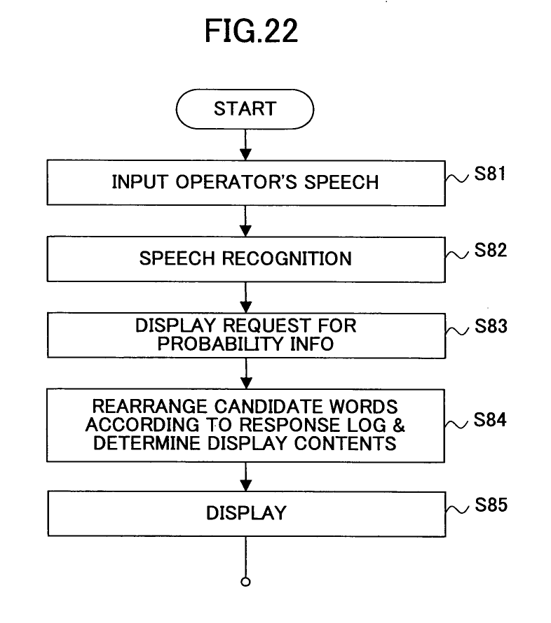

FIG. 22 is a flow chart for explaining a candidate word display sequence changing process of the embodiment of the information input apparatus.

In FIG. 22, when the operator makes an input by speaking “lap-top personal computer”, for example, the microphone input process (or means) 28 inputs the audio signal of the operator's speech and supplies the audio signal to the speech recognition process (or means) 30, in a step S81.

The speech recognition process (or means) 30 carries out a speech recognition with respect to the audio signal using the document structure candidates and the candidate words that are registered in advance in the speech recognition candidate database 32, obtains a plurality of candidate words and certainties as the speech recognition result, and supplies the plurality of candidate words and certainties to the input content analyzing process (or means) 26, as probability information, in a step S82.

The input content analyzing process (or means) 26 generates a display request for displaying and fixing the probability information received from the speech recognition process (or means) 30, and supplies the display request to the response control process (or means) 36, in a step S83.

The response control process (or means) 36 determines the display contents of the candidate word table 55 using the response log holding process (or means) 38 within the memory device 13 and the product information database 40 and the response information database 42 within the database 14, and supplies the display contents to the output content generating process (or means) 44, in a step S84. In this particular case, the response control process (or means) 36 extracts, from the response log holding process (or means) 38, the response log with respect to the candidate word “lap-top personal computer” having the largest certainty with respect to the speech input, obtains the display contents of the candidate word table 57 by rearranging the copying contents depending on the frequency of use of the responses (that is, the coping contents), and supplies the display contents to the output content generating process (or means) 44.

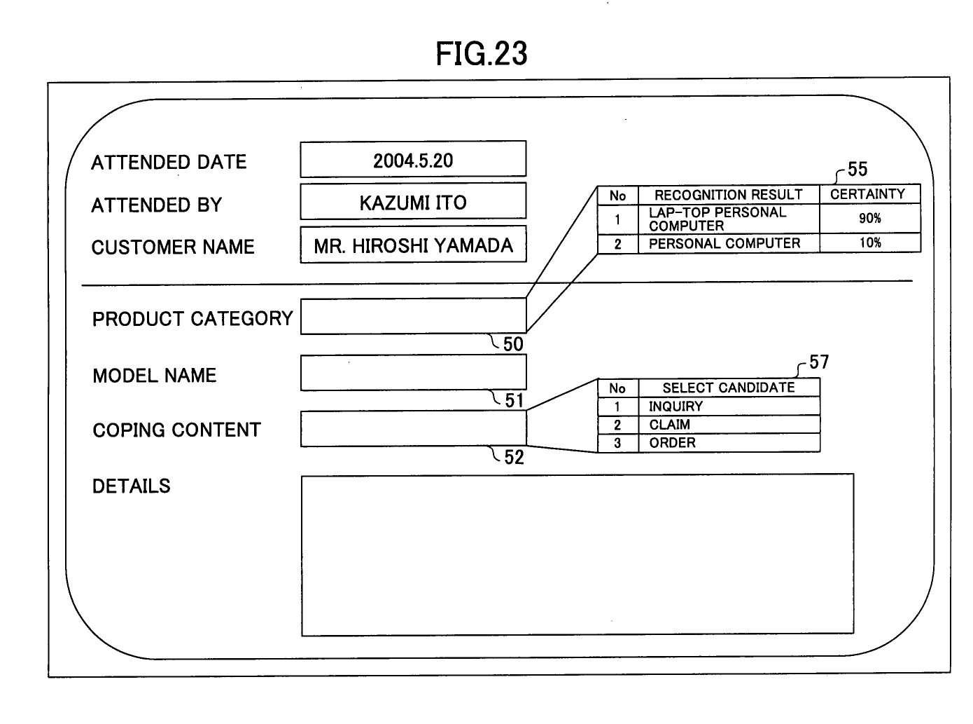

FIG. 23 is a diagram showing a display on the display device. More particularly, FIG. 23 shows a case where the coping contents are rearranged and displayed on the display device. As a result of rearranging the coping contents depending on the frequency of use of the responses, the categories “inquiry”, “claim” and “order” are displayed in this order in the candidate word table 57 shown in FIG. 23.

The output content generating process (or means) 44 generates the screen layout data and the character data depending on the display contents, and supplies a screen output request to the screen output process (or means) 46, in a step S85. The screen output process (or means) 46 generates image data of the display screen based on the screen output request, and displays the image data on the screen of the display device, so as to urge the operator to input the certain information.

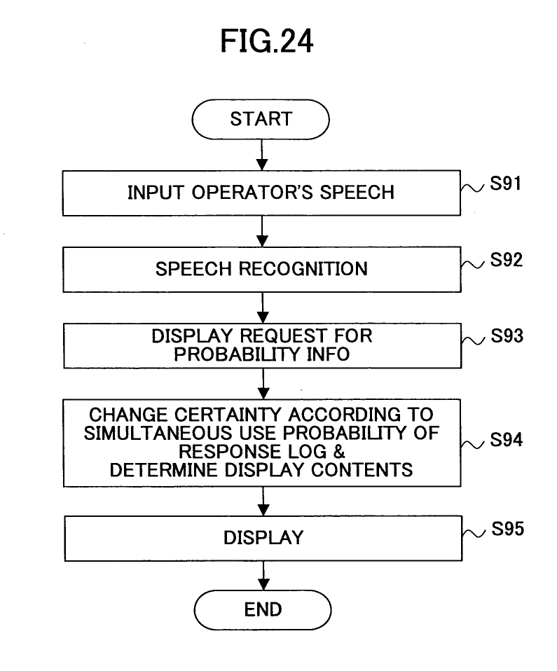

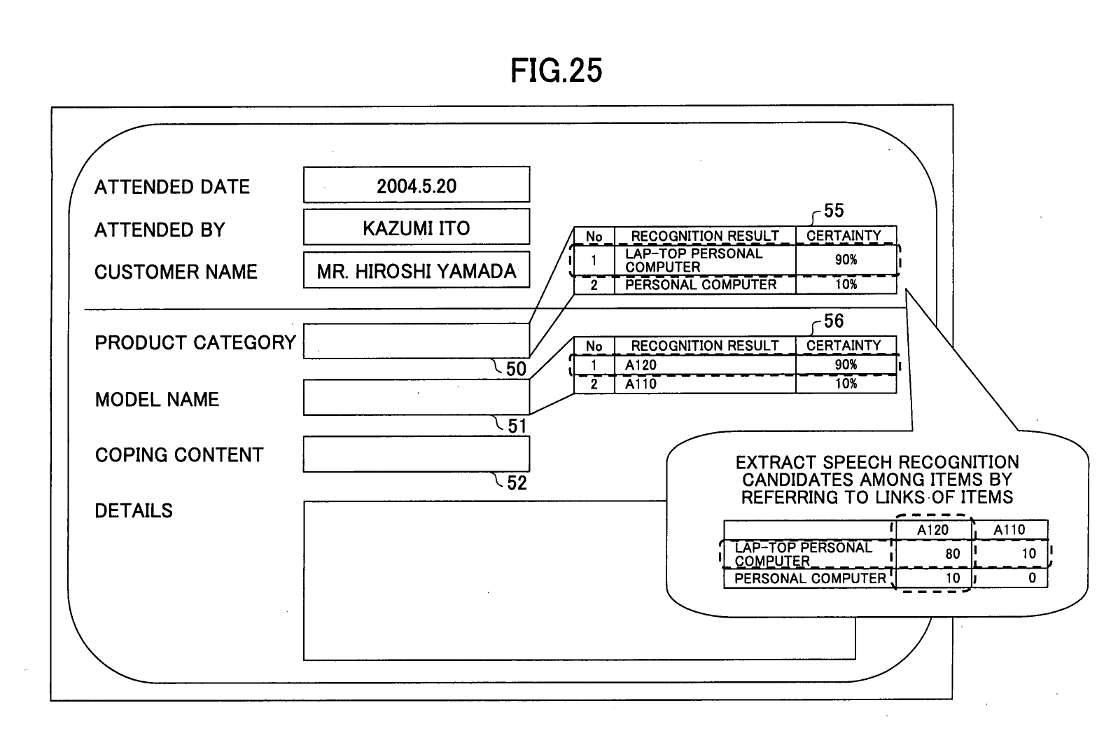

FIG. 24 is a flow chart for explaining a candidate word certainty changing process of the embodiment of the information input apparatus, and FIG. 25 is a diagram showing a display on the display device.

When the operator makes an input by speaking “lap-top personal computer” and “A120”, for example, the microphone input process (or means) 28 inputs the audio signal of the operator's speech and supplies the audio signal to the speech recognition process (or means) 30, in a step S91.

The speech recognition process (or means) 30 carries out a speech recognition with respect to the audio signal using the document structure candidates and the candidate words that are registered in advance in the speech recognition candidate database 32, obtains a plurality of candidate words and certainties as the speech recognition result, and supplies the plurality of candidate words and certainties to the input content analyzing process (or means) 26, as probability information, in a step S92.

The input content analyzing process (or means) 26 generates a display request for displaying and fixing the probability information received from the speech recognition process (or means) 30, and supplies the display request to the response control process (or means) 36, in a step S93.

The response control process (or means) 36 determines the display contents of the candidate word table 55 using the response log holding process (or means) 38 within the memory device 13 and the product information database 40 and the response information database 42 within the database 14, and supplies the display contents to the output content generating process (or means) 44, in a step S94. In this particular case, the response control process (or means) 36 extracts, from the response log holding process (or means) 38, the response log with respect to the speech inputs “lap-top personal computer” and “A120”, and extracts a simultaneous use probability that indicates a probability of “lap-top personal computer” and “A120” being used simultaneously. The response control process (or means) 36 changes (or modifies) the certainties of the candidate words “lap-top personal computer” and “A120” depending on the simultaneous use probability, obtains the display contents of the candidate word tables 55 and 55, and supplies the display contents to the output content generating process (or means) 44.

FIG. 25 shows a case where the certainties of the candidate words “lap-top personal computer” and “A120” are changed and displayed on the display device. The certainty of the candidate word “lap-top personal computer” in the speech recognition is 80% and the certainty of the candidate word “A120” in the speech recognition is 80%, but since the simultaneous use probability of the candidate words “lap-top personal computer” and “A120” is 90%, the display contents of the candidate word tables 55 and 56 are respectively changed to indicate the certainty of 90% for the “lap-top personal computer” and the certainty of 90% for the “A120”.

The output content generating process (or means) 44 generates the screen layout data and the character data according to the display contents, and supplies a screen output request to the screen output process (or means) 46, in a step S95. The screen output process (or means) 46 generates the image data of the display screen based on the screen output request, and displays the image data on the screen of the display device, so as to urge the operator to input the certain information.

In the embodiment described above, the present invention is applied to speech recognition. However, the probability information may be obtained through processes other than speech recognition, such as image recognition. In this case, the microphone input process (or means) 28 may be changed to an image input process (or means), the speech recognition process (or means) 30 may be changed to an image recognition process (or means), and the speech recognition candidate database 32 may be changed to an image recognition candidate database.

The keyboard input process (or means) 20, the mouse input process (or means) 22 and the screen input process (or means) 24 may form a certain information input process (or means). The microphone input process (or means) 28, the speech recognition process (or means) 30 and the speech recognition candidate database 32 may form a probability information input process (or means). The input content analyzing process (or means) 26 may form a selecting and fixing process (or means). The step S34 may form a first candidate limiting process (or means). The step S41 may form an input item selecting process (or means), and the step S43 may form a second candidate limiting process (or means). In addition, the step S62 may form a partial selecting process (or means), and the step S64 may form a third candidate limiting process (or means).

Further, the present invention is not limited to these embodiments, but various variations and modifications may be made without departing from the scope of the present invention.

1. An information input method for inputting certain information and probability information having uncertainty, comprising:
displaying a plurality of candidates with respect to the probability information that is input; and
selecting and fixing one of the plurality of displayed candidates in response to the certain information that is input.

2. The information input method as claimed in claim 1, further comprising:
limiting the plurality of displayed candidates to only those candidates corresponding to the certain information.

3. The information input method as claimed in claim 1, further comprising:
selecting one of a plurality of items each formed by a group of candidates having the same contents in response to the certain information; and
limiting the candidates with respect to the probability information to only those candidates corresponding to the selected item.

4. The information input method as claimed in claim 1, further comprising:
selecting a part of the probability information in response to the certain information; and
limiting the candidates with respect to the probability information to only those candidates having a character corresponding to the selected part of the probability information.

5. The information input method as claimed in claim 1, wherein the probability information that is input relates a plurality of items each formed by a group of candidates having the same contents, and further comprising:
if one of the plurality of items is fixed by the selecting and fixing, simultaneously fixing items of a higher concept than the fixed item.

6. The information input method as claimed in claim 1, further comprising:
if contents identical to the probability information that is input are selected from a display in response to the certain information, simultaneously fixing the candidates with respect to the probability information.

7. The information input method as claimed in claim 6, wherein the display includes a category of conversation examples.

8. The information input method as claimed in claim 6, wherein the display includes a category of a process flow.

9. The information input method as claimed in claim 1, further comprising:
changing a display sequence of candidates belonging to an item with respect to other items depending on a log of the probability information, in response to the probability information, where each item is formed by a group of candidates having the same contents.

10. An information input apparatus comprising:
a certain information input unit configured to input certain information;
a probability information input unit configured to input probability information having uncertainty, and to obtain a plurality of candidates with respect to the probability information;
a candidate display unit configured to display the plurality of candidates; and
a selecting and fixing unit configured to fix and select one of the plurality of displayed candidates in response to the certain information input by the certain information input unit.

11. The information input apparatus as claimed in claim 10, further comprising:
a first candidate limiting unit configured to limit candidates with respect to the probability information input by the probability information input unit to only those candidates corresponding to the certain information input by the certain information input unit.

12. The information input apparatus as claimed in claim 10, further comprising:
an input item selecting unit configured to select one of a plurality of items each formed by a group of candidates having the same contents and obtained by the probability information input unit, in response to the certain information input by the certain information input unit; and
a second candidate limiting unit configured to limit the candidates with respect to the probability information to only those candidates corresponding to the item selected by the input item selecting unit.

13. The information input apparatus as claimed in claim 10, further comprising:
a partial selecting unit configured to select a part of the probability information input by the probability information input unit in response to the certain information input by the certain information input unit; and
a third candidate limiting unit configured to limit the candidates with respect to the probability information input by the probability information input unit to only those candidates having a character corresponding to the part of the probability information selected by the partial selecting unit.

14. The information input apparatus as claimed in claim 10, wherein:
the probability information that is input by the probability input unit relates a plurality of items each formed by a group of candidates having the same contents, and
if one of the plurality of items is fixed by the selecting and fixing unit, items of a higher concept than the fixed item are simultaneously fixed.

15. The information input apparatus as claimed in claim 10, wherein:
if contents identical to the probability information that is input by the probability information input unit are selected from a display in response to the certain information input by the certain information input unit, the candidates with respect to the probability information are simultaneously fixed.

16. The information input apparatus as claimed in claim 15, wherein the display includes a category of conversation examples.

17. The information input apparatus as claimed in claim 15, wherein the display includes a category of a process flow.

18. The information input apparatus as claimed in claim 10, wherein:
a display sequence of candidates belonging to an item with respect to other items depending on a log of the probability information is changed, in response to the probability information input by the probability information input unit, where each item is formed by a group of candidates having the same contents.
